(19) United States
(12) Patent Application Publication
(10) Pub. No.: US 2024/0341272 A1
(43) Pub. Date: Oct. 17, 2024

(54) CAT TREE STRUCTURE

(71) Applicant: Chun-Shan Yeh, Tainan (TW)

(72) Inventor: Chun-Shan Yeh, Tainan (TW)

(21) Appl. No.: 18/634,026

(22) Filed: Apr. 12, 2024

(30) Foreign Application Priority Data
Apr. 14, 2023 (TW) 112203472

(51) Int. Cl. A01K 1/035

(52) U.S. Cl. CPC A01K 1/035

(57) ABSTRACT

A cat tree structure is disclosed, and including a pair of vertical rods, a horizontal plate disposed between the pair of vertical rods and a jumping table disposed on the horizontal plate, and having at least one hook structure and a carrying structure, wherein the hook structure has a main portion and an extension portion, the extension portion is connected at a side of the main portion, the main portion is disposed on the horizontal plate. Through the hook structure of the jumping table, the jumping table of the present disclosure can be conveniently fixed on the horizontal plate or removed from the horizontal plate. Besides, the extension portion of the hook structure can be particular to or in parallel with the front side surface of the horizontal plate so that carrying structure can be designed to multiple forms in to provide a place for cat to jump and stay.

### FIELD OF THE INVENTION

The present invention relates to a pet product, and more particularly to a cat tree structure.

### BACKGROUND OF THE INVENTION

In the recent years, raising pets has gradually become a popular trend. In addition to providing pets food, more and more related products are developed. Taking raising cats as an example, in order to allow cats to have enough space, cat tree products for cats to exercise, stop, and cluster are provided on the market.

With reference to FIG. 5, FIG. 5 is a cat tree structure in the conventional art. As shown in FIG. 5, the conventional cat tree structure 200 includes multiple jumping tables 210. For providing a stable supporting structure for the jumping tables 210, the jumping tables 210 are required to be fixed on the wall through drilling holes. As a result, the noise for construction is large, and the difficulty for removing and changing the assembly is also high.

### SUMMARY OF THE INVENTION

The purpose of the present disclosure is to provide a cat tree structure, which has a stable cat tree structure and could be conveniently fixed and disassembled. The cat tree structure comprises: a pair of vertical rods; a horizontal plate disposed between the pair of vertical rods, wherein the horizontal plate has an upper edge, a front side surface and a rear side surface disposed opposite to the front side surface; and a jumping table disposed on the horizontal plate, and having at least one hook structure and a carrying structure, wherein the hook structure has a main portion and an extension portion, the extension portion is connected at a side of the main portion, the main portion is disposed on the horizontal plate and fixed at the upper edge, the front side surface and the rear side surface, the carrying structure is disposed on the extension portion.

Wherein the extension portion is perpendicular to the front side surface of the horizontal plate, the carrying structure is a flat plate, and the flat plate is a rectangle or a semicircle.

Wherein the extension portion is parallel with the front side surface of the horizontal plate, the carrying structure includes a vertical plate and a hemp-rope column, the vertical plate is fixed to the extension portion and the hemp-rope column is fixed to the vertical plate.

Wherein the shape of the extension portion is a triangle, a width of the triangle is gradually narrow from a side near to the main portion to a front side.

Wherein a side of the main portion is provided with a screw.

Wherein the screw is disposed at the side of the main portion corresponding to the rear side surface of the horizontal plate.

### BRIEF DESCRIPTION OF THE DRAWINGS

FIG. 1 is a three-dimensional diagram of a cat tree structure of the present disclosure;

FIG. 2 is a three-dimensional diagram from another viewing angle of cat tree structure of the present disclosure;

FIG. 3 a three-dimensional diagram of a jumping table according to a first preferred embodiment of the present disclosure;

FIG. 4 is a rear view of a vertical plate according to a second preferred embodiment of the present disclosure; and

FIG. 5 is a three-dimensional diagram of a cat tree structure of the conventional art.

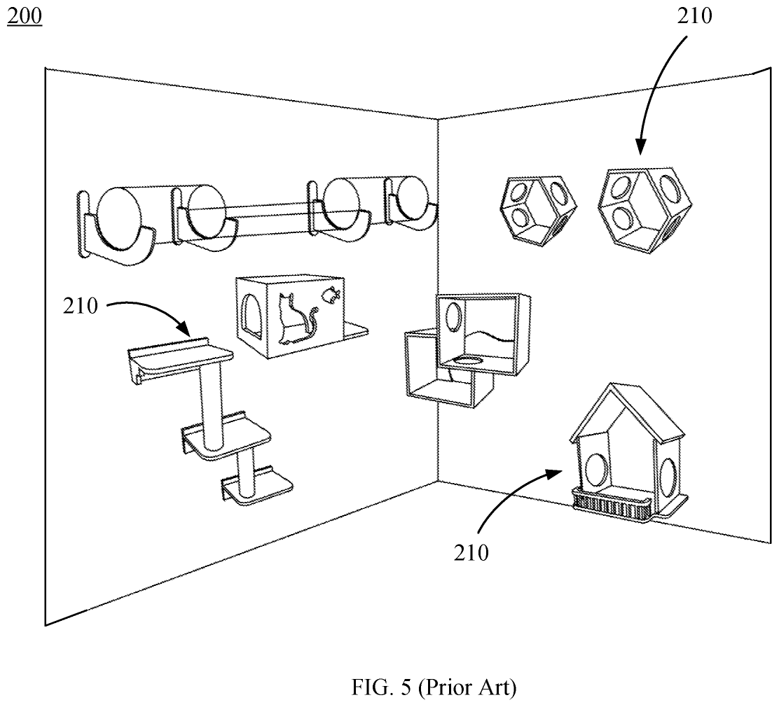

### DETAILED DESCRIPTION OF THE PREFERRED EMBODIMENT

In order to further illustrate the technical solution and effects of the present invention, the following content will combine preferred embodiments with accompanying drawings to describe the present invention in detail.

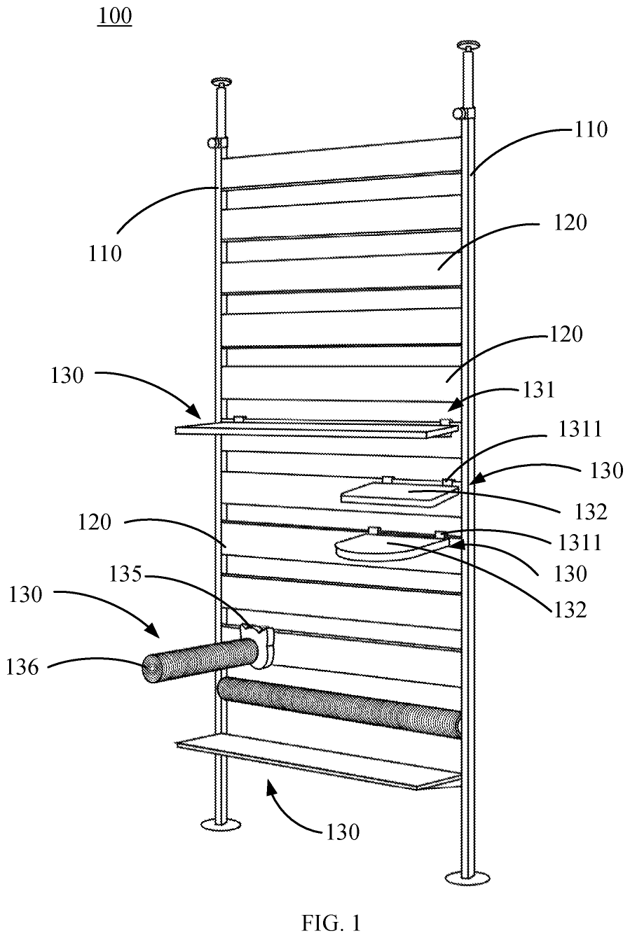

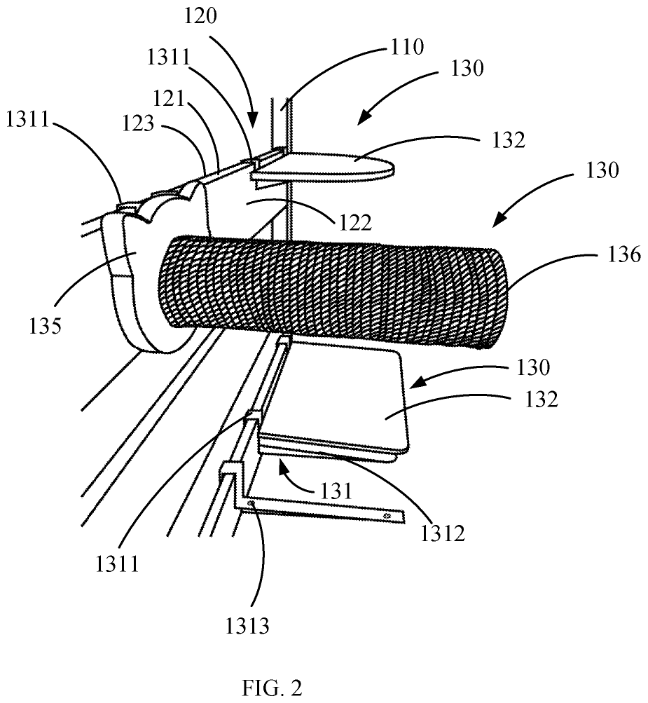

With reference to FIG. 1 and FIG. 2, FIG. 1 and FIG. 2 are three-dimensional diagrams of a cat tree structure of the present disclosure. The cat tree structure 100 of the present disclosure includes a pair of vertical rods 110, at least one horizontal plate 120, and multiple jumping tables 130. The least one horizontal plate 120 is disposed between the pair of vertical rods 110. The horizontal plate 120 has an upper edge 121, a front side surface 122 and a rear side surface 123 disposed opposite to the front side surface 122. Each jumping table 130 has at least one hook structure 131 and a carrying structure 132. The hook structure 131 has a main portion 1311 and an extension portion 1312. The extension portion 1312 is connected at a side of the main portion 1311. Wherein the main portion 1311 is disposed on the horizontal plate 120 and fixed at the upper edge 121, the front side surface 122 and the rear side surface 123. The carrying structure 132 is disposed on the extension portion 1312.

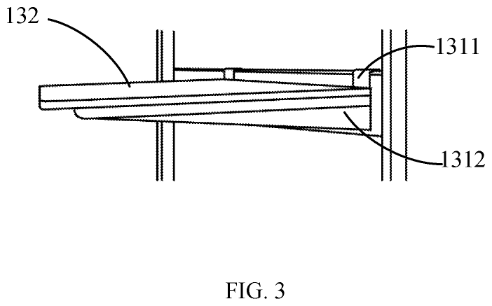

In the first preferred embodiment of the present disclosure, the extension portion 1312 is perpendicular to the front side surface 122 of the horizontal plate 120. The carrying structure 132 is a flat plate. The flat plate can be a rectangle or a semicircle. The extension portion 1312 can have a through hole 1313 such that the carrying structure 132 can be fixed to the extension portion 1312 by an external screw (not shown in the figure). Accordingly, the carrying structure 132 can provide a place for a cat to jump on and stay. Preferably, with reference to FIG. 3, the shape of the extension portion 1312 is a triangle. The width of the triangle is gradually narrow from a side near to the main portion 1311 to a front side in order to increase the whole structure strength of the hook structure of the present disclosure.

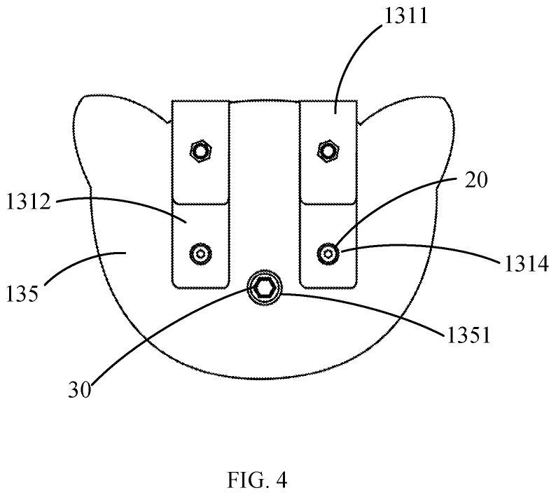

With further reference to FIG. 4, FIG. 4 is a rear view of the vertical plate according to the present disclosure. In the second preferred embodiment, the structure of the main portion 1311 is similar to the first preferred embodiment, but the extension portion 1312 in the present embodiment is in parallel with the front side surface 122 of the horizontal plate 120. The carrying structure 132 includes a vertical plate 135 and a hemp-rope column 136. In the present embodiment, the extension portion 1312 has a first through hole 1314 such that the vertical plate 135 can be fixed on the extension portion 1312 through an external screw 20. The vertical plate 135 is fixed to the extension portion 1312. Besides, the vertical plate 135 has a second through hole 1351, and the hemp-rope column 136 is fixed to the vertical plate 135 by the second through hole 1351 and an external screw 30.

Accordingly, through the hook structure of the jumping table, the jumping table of the present disclosure can be conveniently fixed on the horizontal plate or removed from the horizontal plate. Besides, the extension portion of the hook structure can be particular to or in parallel with the front side surface of the horizontal plate so that carrying structure can be designed to multiple forms in order to provide a place for the cat to jump on and stay.

The above embodiments of the present invention provide an illustration for a digital control driving method, a driving display device and a display device in detail. Specific examples are used herein to describe the principle and implementation manner of the present invention. The above embodiments are only used to help understanding the method and the core idea of the present invention; at the same time, for those skilled in the art, according to the present invention, the embodiments of the present invention will have changes in specific implementation manners and application ranges. In summary, the contents of this specification should not be construed as limiting the present invention.

What is claimed is:

1. A cat tree structure, comprising:
a pair of vertical rods;
a horizontal plate disposed between the pair of vertical rods, wherein the horizontal plate has an upper edge, a front side surface and a rear side surface disposed opposite to the front side surface; and
a jumping table disposed on the horizontal plate, and having at least one hook structure and a carrying structure, wherein the hook structure has a main portion and an extension portion, the extension portion is connected at a side of the main portion, the main portion is disposed on the horizontal plate and fixed at the upper edge, the front side surface and the rear side surface, the carrying structure is disposed on the extension portion.

2. The cat tree structure according to claim 1, wherein the extension portion is perpendicular to the front side surface of the horizontal plate, the carrying structure is a flat plate, and the flat plate is a rectangle or a semicircle.

3. The cat tree structure according to claim 1, wherein the extension portion is parallel with the front side surface of the horizontal plate, the carrying structure includes a vertical plate and a hemp-rope column, the vertical plate is fixed to the extension portion and the hemp-rope column is fixed to the vertical plate.

4. The cat tree structure according to claim 2, wherein the shape of the extension portion is a triangle, a width of the triangle is gradually narrow from a side near to the main portion to a front side.

5. The cat tree structure according to claim 4, wherein a side of the main portion is provided with a screw.

6. The cat tree structure according to claim 5, wherein the screw is disposed at the side of the main portion corresponding to the rear side surface of the horizontal plate.

7. The cat tree structure according to claim 3, wherein a side of the main portion is provided with a screw.

8. The cat tree structure according to claim 7, wherein the screw is disposed at the side of the main portion corresponding to the rear side surface of the horizontal plate.
